(19) United States
(12) Patent Application Publication
(10) Pub. No.: US 2012/0103898 A1
(43) Pub. Date: May 3, 2012

(54) Device And Method For Drinking Water Purification

(75) Inventor: Viktor Zwinger, Westerkappeln (DE)

(73) Assignee: AQUA LIVING GMBH & CO. KG, Westerkappeln (DE)

(21) Appl. No.: 13/055,145

(22) PCT Filed: Jul. 23, 2009
(86) PCT No.: PCT/EP2009/005367

§ 371 Date: Apr. 17, 2011

(30) Foreign Application Priority Data
Jul. 25, 2008 (DE) 10 2008 034 588.1

(51) Int. Cl. C02F 1/44; B01D 65/02; B01D 35/157; B01D 35/147; C02F 1/28; B01D 29/50

(52) U.S. Cl. 210/636; 210/195.2; 210/136; 210/143; 210/138

(57) ABSTRACT

The invention relates to a device (2) for drinking water purification, having a water tank (4) for receiving the drinking water (6) to be purified, a pump (8) for transporting the water, and a membrane filter unit (10) which comprises a water inlet (12), a membrane filter (14), a pure water discharge (16), and a rinsing water discharge (18). The water inlet (12) is supplied with water directly or indirectly from the water tank (4) via a feed line (24), and is disposed in the flow direction (19) in front of the membrane filter (14). The pure water discharge (16) is disposed in the flow direction (19) behind the membrane filter (14). To remove deposits, part of the water fed to the membrane filter unit (10) via the water inlet (12) is guided across the membrane filter surface and exits the membrane filter unit (10) via the rinsing water discharge (18). In order to increase user friendliness, a water return line (26) connects the rinsing water discharge (18) to the water tank (4). Furthermore, the water tank (4) can be removed from the device (2) and filled with drinking water.

The invention concerns a device and a method for drinking water purification according to the preamble of claims 1 and 12.

Such devices and methods for drinking water purification operate independent of a water main connector in that the drinking water to be purified is filled into a water tank of the device and is fed to a membrane filter unit by means of a pump. The water tank, the pump and the membrane filter unit are connected to each other by means of a water conduit. The membrane filter unit has a water inlet, a membrane filter, a pure water discharge, and a rinsing water discharge. The drinking water to be purified is supplied from the water tank to the water inlet arranged upstream of the membrane filter. A portion of the supplied water is pressed through the membrane filter and exits the membrane filter through the pure water discharge. The remaining water supplied to the membrane filter unit is used for cleaning the membrane filter and, for this purpose, is passed across the surface of the membrane filter. This rinsing water entrains in this way deposits located on the surface and exits the membrane filter unit through a rinsing water discharge. The ratio of rinsing water to purified water is approximately 4:1 in this connection. However, it would be desirable to have a utilization ratio that is changed to be more beneficial with regard to the purified water in order to have to refill the water tank less frequently and to thereby increase the user-friendliness. Also, the cleaning action and safety considerations that must be fulfilled make handling of known devices more difficult.

The invention has therefore the object to provide a device and a method for drinking water purification of the aforementioned kind with increased user-friendliness.

The invention solves this object by a device with the features of claim 1 and a method with the features of claim 11. Further advantageous embodiments of the invention are disclosed in the dependent claims 2 to 10 as well as 12 to 18. According to the invention, the rinsing water discharge is connected by a water return conduit with the water tank. The rinsing water employed for rinsing the membrane filter surface is returned through the water return conduit into the water tank and subsequently is supplied again to the membrane filter. The drinking water to be purified that has been filled into the water tank is supplied in this way several times to the membrane filter and, each time, a portion of this water is pressed through the membrane filter while the remaining supplied portion of the water is employed for rinsing the membrane filter surface. The device forms a self-contained system and the water tank is therefore not connected additionally to a water main connector. Already for this reason it is desirable to be able to remove, in the form of purified water, a portion as high as possible of the drinking water to be purified and contained in the water tank from the device or by the method and to dispose of water contained in the water tank in the form of rinsing water in a quantity as small as possible. For example, when 1.8 liters of drinking water are supplied for purification into the water tank of the device, by multiple returns of the rinsing water into the water tank in the end, for example, 1.4 liters of purified water are obtained and only 400 ml of rinsing water remain. The quality of the water contained in the water tank decreases as the contained contaminants are increasingly concentrated successively. The quality of the purified water that is exiting through the pure water discharge of the membrane filter units is however always of the same high quality. Regular drinking water is used as water to be purified. The membrane filter retains disturbing contaminations such as undesirable ions, medication residues, pesticides, herbicides, hormones or also residues of hydrocarbon molecules which are or may be contained in the drinking water.

According to the invention, the water tank is removable from the device for filling it with drinking water. In this connection, the water tank is separated from the pump and the filter, is transported to a dispensing location of drinking water to be purified, and is filled thereat with drinking water. Since the water tank is not connected to a water main connector, this configuration facilitates filling of the water tank with the drinking water to be purified.

In an advantageous embodiment the device has an auxiliary conduit through which liquid that has been removed by the pump from the water tank can be returned into the water tank, wherein the auxiliary conduit is closable by a valve. When removing the water tank from the device and subsequently reinserting the tank filled with water into the device, there is air in the water conduit between the water tank and the pump and, for optimal operation of the device, should be removed first. For venting the pump and/or the water conduit between the water tank and the pump, the water that has been sucked in by the pump from the water tank or also a water/air mixture is first completely returned for a predetermined amount of time, preferably 0.5 to 10 seconds, into the water tank without flowing through a filter prior to this. By providing the auxiliary conduit, a simple venting of the pump as well as of the water conduit between the water tank and the pump is possible without losing the water contained in the water tank.

Advantageously, in flow direction of the water between the rinsing water discharge and the water tank a check valve is arranged. In this way, it is achieved that no water from the water tank can flow through the rinsing water discharge opposite to the given rinsing direction into the membrane filter unit.

In an especially preferred embodiment of the invention the device comprises a ceramic filter that in flow direction of the water is arranged behind the pure water discharge of the membrane filter unit. The water to be purified flows thus first through the membrane filter and subsequently through the ceramic filter. Surprisingly, it has been found that positioning a ceramic filter downstream of the membrane filter further improves the taste of the obtained water. Moreover, in case of improper use, microorganisms that may have developed within the membrane filter are retained by the ceramic filter and therefore do not reach the pure water to be removed from the device.

In an advantageous embodiment of the invention, the membrane filter has an active carbon filter arranged upstream. Advantageously, it is possible to separate the active carbon filter from the hydraulic flow. For this purpose, the device has a bypass conduit and a valve, in particular a three-way valve with which the active carbon filter can be bypassed and completely separated from the hydraulic flow. In this connection, hydraulic flow is to be understood as the flow of the water to be purified through the filters during the process of water purification. The possibility of separating the active carbon filter enables cleaning of the surfaces of all other components that are in contact with water by means of a cleaning agent, in particular with an oxidizing agent such as, for example, hydrogen peroxide. The cleaning agent would otherwise destroy the active carbon filter so that cleaning of the device would not be possible.

In an advantageous embodiment of the invention the device, in flow direction of the water, is provided between the rinsing water discharge and the water tank and/or downstream of the last filter with a conductance sensor for determining the conductivity of the water. By means of the conductance sensors, the quality of the pure water leaving the device can be monitored and optionally can be displayed to the consumer on a display. By means of the conductance sensor arranged between the rinsing water discharge and the water tank it is moreover possible to measure and optionally display the degree of contamination of the rinsing water. Proper functioning of the device can therefore be measured in a simple way and indicated on a display.

In a preferred embodiment of the invention, the water conduit between the water tank and the membrane filter can be pressure-relieved by means of a valve to be opened that comprises a pressure relief opening. In this connection, the valve is arranged in an especially preferred arrangement between the pump and the first filter. Advantageously, the pressure relief opening is connected by means of a pressure relief conduit with an inlet opening that opens into the water tank and is located below a minimum water level of the water tank required for operation of the device. After termination of the water purification the water-conducting parts of the device are still under pressure that is deviating from ambient pressure. By means of a direct connection of the water conduit that is under overpressure or underpressure either to the environment or to the water tank, the water conduit is pressure-relieved. In this connection, generally water will be spraying out of the pressure relief opening. As a result of the optional connection of the pressure relief opening with the inlet opening, the water sprays into the water tank and the surroundings of the device remain dry. Since the inlet opening is arranged moreover below the water level, spraying of water out of the tank is prevented additionally.

In an advantageous embodiment of the invention the device has a safety device for automatically switching off the pump. The safety device comprises a sensor for measuring the current consumption of the pump and a control unit that switches off the pump when a predetermined course of the current consumption occurs. While the pump pumps water from the water tank and presses the water through the membrane filter, the current consumption of the pump is nearly constant. The water quantity contained in the water tank decreases in this connection continuously until a lower limit is reached in which an outlet opening through which the water exits from the water tank is positioned above the water level of the water still remaining in the water tank. The pump now sucks in air. The current consumption of the pump thus decreases very quickly. However, subsequently the air within the section between the pump and the membrane filter must be compressed and the current consumption of the pump will then suddenly increase again strongly. The control unit recognizes this characteristic course of the curve and, based on this, switches off the pump.

Advantageously, the device, in addition or alternatively to the aforementioned safety device, has a time control that switches off the pump automatically after lapse of a predetermined time interval beginning with switching on the pump. Since the water tank has only a limited capacity for receiving water to be purified, the device requires a predetermined time interval for processing the maximum water quantity contained in the water tank. The time control then switches off automatically after lapse of this time interval and prevents in this way that the pump accidentally is running idle for an extended period of time. The pump would otherwise be damaged and would moreover consume energy unnecessarily.

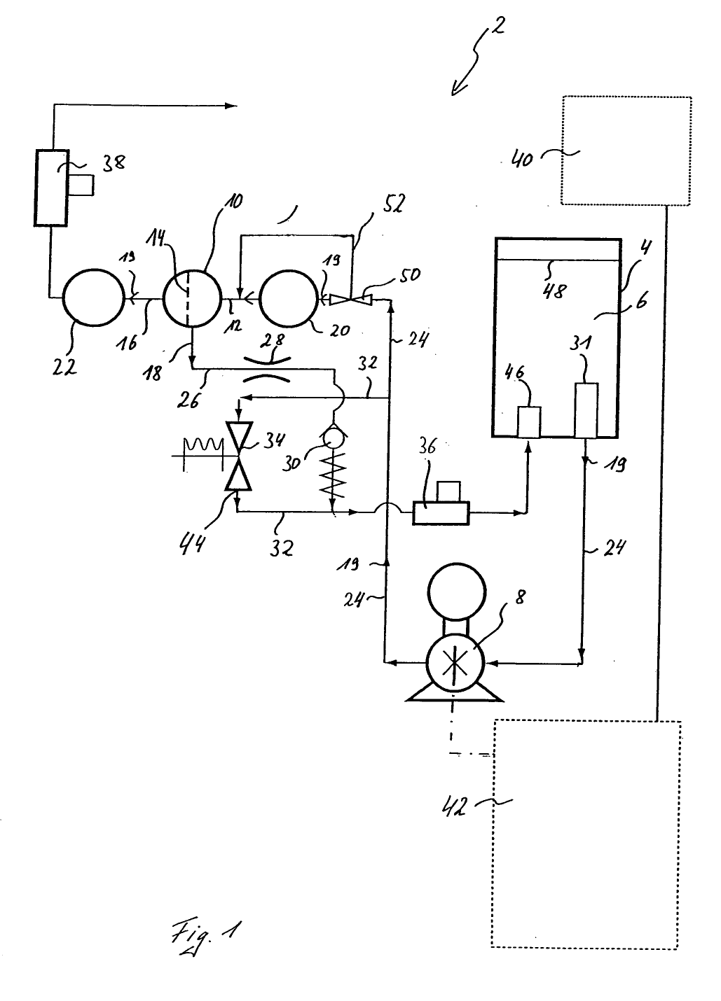

Further advantageous embodiments and details of the invention will be explained in more detail with the hydraulic circuit diagram of one embodiment of the device according to the invention as well as of the method according to the invention illustrated in FIG. 1. In the following, elements of the circuit diagram that are acting in the same way are provided with consistent reference numerals if this is expedient. All of the features of the embodiment disclosed in the following may be subject matter of the invention individually or also in any combination with further disclosed features.

FIG. 1 shows a hydraulic circuit diagram of a device 2 according to the invention with a water tank 4 for receiving the drinking water 6 to be purified, a pump 8 for the transport of the water, and a membrane filter unit 10. The membrane filter unit has a water inlet 12, a membrane filter 14, a purified water discharge 16, and a rinsing water discharge 18. The membrane filter unit 10 in flow direction 19, illustrated by arrows in the hydraulic circuit diagram, has arranged upstream thereof an active carbon filter 20 and a downstream thereof a ceramic filter 22. The water inlet 12 of the membrane filter unit 10 is supplied from the water tank 4 by means of an inlet conduit 24 indirectly after passing through the active carbon filter 20. The water inlet 12 is arranged in flow direction 19 in front of the membrane filter 14. The water to be purified flows partially through the membrane filter 14 and exits the membrane filter unit 10 through the pure water discharge 16 that in flow direction 19 is arranged behind the membrane filter 14. The remaining portion of the water supplied through the water inlet 12 to the membrane filter 14 is passed, for removal of deposits, across the membrane filter surface and exits the membrane filter unit 10 subsequently through the rinsing water discharge 18. The rinsing water discharge 18 is connected with the water tank 4 by means of a water return conduit 26. For maintaining an increased pressure in the membrane filter unit 10 the water return conduit 26 has installed therein a throttle valve 28 for reducing the pressure. Moreover, the water return conduit 26 has a check valve 30 that is flowed through by the rinsing water before the water flows back into the water tank 4.

The device is embodied as a tabletop device for being placed onto a table or a sideboard without a water main connector. For easier filling of the water tank 4 with water 6 to be purified the water tank 4 can be removed from the device 2.

After reinsertion of the filled water tank 4 into the device 2, there is air in the inlet conduit 24. In order to remove it, the liquid that has been sucked in from the water tank 4 through the outlet opening 31 by the pump 8 can be returned by an auxiliary conduit 32 into the water tank 4. As soon as the air from the inlet conduit 24 has been removed in this way, the auxiliary conduit 32 is closed by a valve 34, in particular a solenoid valve, and the water flows now through the filters 20, 14, 22 instead of passing through the auxiliary conduit 32. Now the actual purification of water begins.

For checking the quality of the water that is returned through the water return conduit 26 into the water tank 4, the device 2 has a first conductance sensor 36. In addition, in flow direction 19 behind the ceramic filter 22 a further conductance sensor 38 is arranged that measures the conductance of the purified water that is leaving the device 2. The purity or also the level of contamination can be determined by means of the measured conductance and is displayed in the illustrated embodiment on a display 40.

The device 2 has a safety device for automatically switching off the pump 8. The safety device comprises a sensor, not illustrated in the circuit diagram, for measuring the current consumption of the pump 8 and comprises a control unit 42. For a predetermined course of the current consumption of the pump 8, the pump is automatically switched off by the control unit 42.

After termination of water purification a pressure within the water conduits, for example, in the inlet conduit 24, may exist that deviates from ambient pressure. For pressure relief, the inlet conduit 24 between the water tank 4 and the membrane filter 14 can be relieved of pressure by means of a valve to be opened that comprises a pressure relief opening 44. In the illustrated embodiment, for this purpose the auxiliary conduit 32 comprising valve 34 is employed. However, a separate valve for pressure relief is also conceivable. The pressure relief opening 44 is connected by means of a pressure relief conduit, identical with the auxiliary conduit 32 in the embodiment, to an inlet opening 46 opening into the water tank 4. The inlet opening 46 is arranged in the water tank 4 below a minimal water level 48 that is required for operation of the device 2. In this way, spraying of water upon pressure relief is prevented.

The active carbon filter 20 that is arranged between the water tank 4 and the membrane filter unit 10 can be bypassed by a valve 50 and a bypass conduit 52 and can be separated completely from the hydraulic flow.

What is claimed is:

1.-17. (canceled)

18. A device for drinking water purification, the device comprising:
a water tank holding drinking water to be purified;
a membrane filter unit comprising a water inlet, a membrane filter, a clean water discharge, and a rinsing water discharge;
an inlet conduit connecting the water tank to the water inlet, wherein water is supplied directly or indirectly from the water tank to the water inlet that is arranged in a flow direction of the water upstream of the membrane filter;
a pump disposed in the inlet conduit for pumping water from the water tank to the membrane filter unit;
wherein the clean water discharge in the flow direction is arranged downstream of the membrane filter;
wherein a portion of water supplied to the membrane filter unit through the water inlet is passed across a surface of the membrane filter for removal of deposits and exits the membrane filter unit through the rinsing water discharge;
a water return conduit connecting the rinsing water discharge to the water tank;
wherein the water tank is removable from the device to allow filling with water.

19. The device according to claim 18, comprising an auxiliary conduit branching off the inlet conduit downstream of the pump and a valve disposed in the auxiliary conduit for closing or opening the auxiliary conduit, wherein water transported in the inlet conduit is returned through the auxiliary conduit into the water tank when the valve opens the auxiliary conduit.

20. The device according to claim 18, comprising a check valve arranged in the water return conduit between the rinsing water discharge and the water tank.

21. The device according to claim 18, comprising a ceramic filter that, in the flow direction, is arranged downstream of the pure water discharge.

22. The device according to claim 18, comprising a first conductivity sensor for determining a conductivity of the water, wherein the conductivity sensor is arranged in the flow direction downstream of the ceramic filter.

23. The device according to claim 22, wherein in the flow direction between the rinsing water discharge and the water tank a second conductivity sensor is arranged for determining the conductivity of the water.

24. The device according to claim 18, wherein in the flow direction between the rinsing water discharge and the water tank a conductivity sensor is arranged for determining the conductivity of the water.

25. The device according to claim 18, comprising a valve with a pressure relief opening, wherein the valve is disposed in the inlet conduit between the water tank and the membrane filter for relieving pressure in the inlet conduit.

26. The device according to claim 25, comprising a pressure relief conduit connecting the pressure relief opening to an inlet opening of the water tank, wherein the inlet opening is disposed below a minimal water level in the water tank, which minimal water level is required for operation of the device.

27. The device according to claim 18, comprising a safety device for automatically switching off the pump, wherein the safety device comprises a sensor for measuring a current consumption of the pump and further comprises a control unit that switches off the pump when a predetermined course of the current consumption occurs.

28. The device according to claim 18, comprising a time control that switches off the pump automatically after lapse of a predetermined time interval.

29. The device according to claim 18, comprising an active carbon filter that is arranged in the inlet conduit between the water tank and the membrane filter unit and further comprising a bypass conduit provided with a valve for opening and closing the bypass conduit, wherein the bypass conduit branches off the inlet conduit and wherein the active carbon filter is bypassed through the bypass conduit and completely separated from a flow of water through the device when the valve opens the bypass conduit.

30. A method for drinking water purification in a device comprising a water tank holding drinking water to be purified; a membrane filter unit comprising a water inlet, a membrane filter, a clean water discharge, and a rinsing water discharge; an inlet conduit connecting the water tank to the water inlet; a pump disposed in the inlet conduit for pumping water from the water tank to the membrane filter unit; a water return conduit connecting the rinsing water discharge to the water tank; the method comprising the steps of:
supplying water to be purified that is stored in the water tank to a membrane filter;
pressing a first portion of the water through the membrane filter and rinsing with a remaining second portion of the water a surface of the membrane filter facing the water to be purified;
returning the second portion of the water used for rinsing into the water tank and supplying the second portion of the water used for rinsing again to the membrane filter;
separating the water tank for filling with water from the pump and the filter medium unit, transporting the water tank to a dispensing location for the water to be purified, and filling the water tank with the water to be purified.

31. The method according to claim 30, comprising the step of venting at least one of the pump and the inlet conduit between the water tank and the pump by completely returning, for a predetermined amount of time, the water, sucked by the pump from the water tank into the inlet conduit, into the water tank without the water flowing first through the membrane filter unit.

32. The method according to claim 30, comprising the step of first passing the water to be purified through an active carbon filter, then through the membrane filter unit, and subsequently through a ceramic filter.

33. The method according to claim 32, comprising the step of separating the active carbon filter from a flow of the water through the device in order to purify surfaces of components of the device that are in contact with the water.

34. The method according to claim 30, comprising the steps of:
measuring by a conductivity sensor a purity of at least one of the water having flowed through the membrane filter unit and the water used for rinsing; and
evaluating conductivity values measured by the conductivity sensor.

35. The method according to claim 30, comprising, after termination of water purification, the step of relieving overpressure or underpressure still existing in the device by opening a conduit that introduces a portion of the water that is under pressure into the water tank below the water level of the water still contained in the water tank.

36. The method according to claim 30, comprising the step of measuring a current consumption of the pump and automatically switching off the pump when a predetermined course of the current consumption occurs.
